(19) United States
(12) Patent Application Publication
(10) Pub. No.: US 2010/0019482 A1
(43) Pub. Date: Jan. 28, 2010

(54) Method to personalize real estate brochures, postcards, books, and photo documents using radio frequency identification tags

(76) Inventors: Monto H. Kumagai, Davis, CA (US); Philip Miller, Leucadia, CA (US)

Correspondence Address: MONTO H. KUMAGAI, 36785 Russell Boulvard, DAVIS, CA, 95516, US

(21) Appl. No.: 12/573,880

(22) Filed: Oct. 5, 2009

Related U.S. Application Data
(63) Continuation-in-part of application No. 11/560,863, filed on Nov. 17, 2006, now Pat. No. 7,598,869.
(60) Provisional application No. 60/738,105, filed on Nov. 17, 2005.

(51) Int. Cl. B42D 15/00; H04Q 5/22

(52) U.S. Cl. 283/72; 340/10.51

(57) ABSTRACT

The present invention provides a method to personalize and enhance photo documents. It utilizes radio frequency identification (RFID) tags, computers, PDAs, and cell phones to link, record, and retrieve positional, personal, and historical data. The personalization and association of a photo document to a unique event by the consumer will lead to an enhanced value of the product. Photo documents containing RFID tags are associated with personal images, movies, text, and audio files. Information that is stored on cell phones, PDAs, computers, and external databases is transferred and shared using cellular networks, email, text, and multimedia messaging. This invention describes a system to record, retrieve, and share personal experiences and event information in association with commercial products such as real estate properties.

This application claims benefit of U.S. Provisional Application No. 60/738,105, filed Nov. 17, 2005. This application is a Continuation in Part of U.S. application Ser. No. 11/560,863, filed Nov. 17, 2006.

### FIELD OF INVENTION

This invention relates to a method to personalize real estate brochures using radio frequency identification (RFID) tags. During a tour of a house for sale, information or links to information such as personal images, movies, text, and audio files are written on real estate brochures that contain RFID tags using RFID-enabled cell phones. This invention describes a system to promote, share, and distribute personal information on real estate properties.

### BACKGROUND OF THE INVENTION

### Sample Tracking and Data Storage System

We have developed electronic tracking systems and databases to store diverse information. Barcodes are currently in wide use for tracking. Although barcodes are convenient to use indoors, they have limitations for use in the outdoor environment. To record data on a barcode requires a thermal printer and computer. We have developed a novel “electronic barcode” system that uses radio frequency identification (RFID) tags and use the tags as an alternate media to “traditional” barcodes to enhance the value of consumer recreational items.

RFIDs are devices that are queried by radio frequency transmission and may be operated without external power. The miniaturized tag is about the size of a postage stamp and can store up to 32 kilobytes of data. This feature is highly desirable for use in outdoor settings.

The RFID or radio frequency identification tags are electronic alternatives to barcodes. RFID tags are coming into wide use in the electronics industry. New applications are being rapidly developed as costs continue to drop and capacities increase. The proposed system uses modified handheld computers (PDAs) and cell phones to read, write, and store information to and from the RFID tags. Since many of the RFID applications are performed outdoors, a major challenge is to keep track of the item identification number and the precise location where the event was experienced. In our application, we describe a method to record consumer relevant information using cameras that are attached to the handheld computers or cell phones. The stored images, date, time, comments, voice recordings, and global positional settings (GPS) have been linked to RFID tags and relational databases.

The method we describe to promote and distribute personal information on real estate properties that consists of the following steps or processes: enhance, experience, personalize, recall, and share. Although there is similar art that covers some portions of the procedure, this invention describes the integration of the parts that results in a robust, inexpensive, mobile method to advertise real estate. This method is especially useful for touring houses for sale. The enhancement step begins with the association of photo documents to an RFID tag. The electronic, RFID devices have been described and we have shown that they are able to withstand extreme changes in temperature, pressure, and liquid environments. RFID tags can be embedded during the manufacturing process or they can be directly added to the finished product (ie. photo, book or brochure). In one example we have placed a RFID tag in a real estate brochure that is used to advertise a property. After the RFID tag is attached to the flyer, the user in the outdoor environment previews the real estate property. For example, an open house was visited in Kailua, HI. Personal impressions, information, and links about the property were recorded and transferred to the RFID-enabled brochure. The data in the examples were GPS readings, measurements and details (size, number, and color of rooms), personal comments, photos, audio, or video files. Transferring the information to the real estate brochure resulted in a personalized photo document. There are examples of this process in the electronic industry where an individual adds preferred artwork, photos, and audio files to cell phones, portable music players, and laptop computers. The personalized RFID product is queried after the experience. For example, a consumer returns from a real estate viewing trip and reads his brochure using an RFID-enabled cell phone. Information about the house is replayed on the screen of the cell phone. RFID technology is used to quickly retrieve information that was previously recorded. Recalling the event is a rewarding experience and results in acquiring and retaining real estate information that can be used to make an informed decision. Since the information is presented on a mobile cell phone or laptop computer it can be quickly shared with others using email, cellular, or multi media messaging (MMS). We have developed an inexpensive mobile, method that uses the RFID serial numbers as unique identifiers to send, store, and retrieve information.

### DESCRIPTION OF THE RELATED ART

In the past, inventory control has become a major challenge. As the number of samples increase and the conditions in which they are stored change, there has been a need to develop new methods. There have been procedures to track samples using RFID. U.S. Pat. No. 5,743,815 showed a method to remotely track dispersed objects (golf balls) containing implanted RFID tags in the environment. A RFID system to locate lost golf balls was described in U.S. Pat. No. 5,626,531. Methods for tracking mobile organisms using implanted RFID tags and integrated databases were described in U.S. Pat. No. 5,235,326. In U.S. Pat. No. 5,631,835, RFID technology was developed to track materials (garbage) in a mobile environment and to maintain processing records. In U.S. Pat. No. 5,139,744, methods were developed to monitor microtiter plates in automated laboratories. U.S. Pat. No. 5,832,488 showed the use of smart cards to store and process information concerned with the history of the laboratory procedures. Computer systems have been developed to track large numbers of RFID tags in various indoor and outdoor environments. U.S. Pat. No. 7,102,509 showed how RFID tags can be used to monitor inmate populations in prisons, alternate environments, and homes.

There is prior art that showed methods to track and store data associated with agricultural products, recreational equipment, or outdoor events. U.S. Pat. No. 6,796,504 utilized a RFID system to track GMO products and U.S. Pat. No. 6,859,672 described a method to link food products with their food source. Non-visual identification of fishing gear using RFID tags was described in U.S. Pat. No. 7,025,254. U.S. Pat. No. 6,836,215 on RFID enabled wristbands and U.S. Pat. No. 6,614,392 on GPS and intelligent labels can be used in recreational activities. Photos of outdoor events are stored and retrieved using RFID technology described in U.S. Pat. No. 6,785,739. A method that utilized RFID tags in a hunting tournament was described in U.S. Pat. No. 6,317,030.

RFID technology can be used to write information onto children's toys. U.S. Pat. No. 7,066,781 showed that RFID tags could be used to enhance the personality of a toy and could be used in interactive games. Internal placement of the tags within a toy allowed for non-evasive, wireless communication of stored data.

Handheld devices such as modified cell phones, PDAs, and portable computers have been developed which are capable of reading, writing, and transmitting RFID data. U.S. Pat. No. 7,117,374 described how to scan objects with handheld devices to trigger access to internet web sites and other databases. U.S. Pat. No. 7,123,696 showed that visiting a specific web page can trigger the retrieval of personalized media clips. Methods that enhance telecommunication services by combining cell and RFID technology was described in U.S. Pat. No. 7,127,261.

### SUMMARY OF THE INVENTION

The present invention describes a method to record and share personal information on real estate properties using radio frequency identification (RFID) tags and real estate brochures.

The method is comprised of the following steps: 1) attach an RFID tag to a real estate brochure; 2) experience and record personalized event information that includes personal audio, video, and text files during a tour of a real estate property; 3) transfer the information or links to the information to the RFID-tagged brochure; 4) replay the personalized event information by placing a cell phone, computer, or PDA near the RFID-tagged brochure; and 5) share the personalized event information that was obtained from the RFID tagged brochure by cellular, email, or multimedia messaging.

In one embodiment an enhanced photo document is presented, an RFID tag being attached to a real estate brochure. The RFID tag contains personalized event related information or a link to the information deposited on the RFID tag.

In this embodiment, the enhanced brochure can be but is not limited to a brochure describing a real estate item wherein the brochure is a real estate announcement wherein the item is property for sale, rent, or auction.

In another embodiment we present a method of enhancing photo documents by attaching an RFID tag to a book, recording personalized event information, depositing the event information on the RFID tag during the event. In this embodiment, the document can be but is not limited to a book wherein the book is a real estate announcement wherein the item is property for sale, rent, or auction. One or more information links could be included on the RFID tag. Different information elements can be deposited on the RFID tag before, during or after the event to which the enhanced item is relevant.

In another embodiment a real estate brochure can be enhanced by the steps of attaching an RFID tag to the brochure, viewing the property with the RFID-tagged brochure, recording information such as GPS data, size and number of rooms, price, estimated value, photos, audio files, and video files and/or a link to information and transferring the information to the RFID-tagged brochure to be recalled later. The information can then be recalled and shared.

In another embodiment a method of recording and recalling a consumer experience is presented. The method involves the steps of associating an RFID tag to a real estate brochure to allow the RFID-tagged brochure to be associated with an event. Experiencing the event with the RFID-tagged brochure, recording information comprising personal and historical information associated with said event, and depositing the information on the RFID tagged brochure so that the experience can be recalled from the RFID tag, recalling said information and sharing the information. The RFID-tagged brochure can be but is not limited to a brochure describing a real estate item wherein the brochure is a real estate announcement wherein the item is property for sale, rent, or auction.

In another embodiment, a method is presented for personalizing photo documents that are associated with real estate properties, the method comprising: (a) linking; (b) recording; and (c) retrieving positional, personal, and historical data. The document can be but is not limited to a brochure describing an item wherein the brochure is a real estate announcement wherein the item is property for sale, rent, or auction; a book wherein the book is a real estate announcement wherein the item is property for sale, rent, or auction; and a postcard wherein the postcard is a real estate announcement wherein the item is property for sale, rent, or auction.

In another embodiment, a method is presented for retrieving and sharing personalized event-related information wherein the subject line of a message or name of a data set is an RFID identifier.

In another embodiment, a tracking and recording system is presented. The tracking and recording system includes a recording device, a document, an RFID tag attached to the document, the RFID tag containing personalized event-related information that has been captured by the recording device and electronically deposited on the tag, an information retrieval device, and a database. The recording and retrieval device can be but is not limited to a RFID-enabled cell phone, a RFID-enabled PDA or a RFID-enabled computer, a RFID-enabled music, photo, or video player. The document can be but is not limited to a brochure describing an item wherein the brochure is a real estate announcement wherein the item is property for sale, rent, or auction.

In another embodiment, a method is presented for using an RFID tag. The RFID tag is attached to an item that is associated with said real estate event. The method comprises recording on the RFID tag personalized event information such as location, time, and events that are associated with a real estate event. The real estate event can be a one-time event, a periodic event, or an occasional event or a reoccurring event. The document can be but is not limited to a brochure describing an item wherein the brochure is a real estate announcement wherein the item is property for sale, rent, or auction.

### BRIEF DESCRIPTION OF THE FIGURES

Those skilled in the art will understand that these embodiments are representative only of many consumer items containing RFID tags. All such materials are contemplated and intended to be within the scope of the present invention.

FIG. 1 is a flow diagram showing a three step process for making and using the enhanced photo document to recall and share an experience.

FIG. 2 shows a RFID signpost recreational item that includes a hat, patch, and an RFID transponder.

FIG. 3 is a flow diagram in which step 7 an RFID tag is attached to a photo document; in step 8 data is recorded and transferred to the RFID tag; in step 9 recorded data is transferred to a database. This is done where more information is recorded than can be placed on an RFID tag. The database address is recorded is stored on the RFID tag, so that when performing step 10, recalling and sharing the recorded event, the database can be called up to provide the supplementary information about the event that is being recalled or shared.

FIG. 4 shows an RFID postcard that includes a postcard, stamp, and an RFID transponder.

### DESCRIPTION OF THE SPECIFIC EMBODIMENTS

### Definitions

In order to provide a clear and consistent understanding of the specification and the claims, including the scope given herein to such terms, the following definitions are given:

The term “attached” refers to the placement of the RFID tag on documents. They are in close association with each other. The RFID tag can be placed on, below, or within the document.

The term “personalized event related information” refers to data that is personal and/or historical in nature. It includes but is not limited to names, ages, measurements, records, benchmarks, events, time, dates, seasons, climates, temperatures, pressures, locations, GPS positions, altitudes, unique identifiers, RFID numbers, database links, addresses, listed prices, and estimated values.

The term “RFID identifier” or “RFID number” refers to a unique symbol consisting of numbers and/or letters. We provide examples of sixteen-decimal RFID identifiers. Often the RFID numbers are assigned to the individual tags during the manufacturing process. Since the numbers are rare or unique they can be used as names of objects in large, diverse databases. The identifier can also be a combination of a unique symbol and time and/or location.

The term “document” refers to an object that is involved in providing information to the consumer. Document includes but is not limited to a brochure wherein the brochure is a real estate announcement, an advertisement wherein the real estate is a house, condominium, property, commercial business, or resort; and a card wherein the card is a postcard.

The term “photo document” refers to a photograph that is attached to a document that is involved in providing information to the consumer. Photo documents include but are not limited to brochures wherein the brochures are real estate announcements, advertisements wherein the real estate is a house, condominium, property, commercial business, or resort; a card wherein the card is a postcard; and a book wherein the book contains photos.

The term “enhanced photo document” refers a photo document that has personalized event related information written on the RFID tag.

The term “consumer item” refers to a commercial product that has been acquired by an individual for direct use or personal ownership.

The term “enhanced intrinsic value” refers to an increase in the worth of an item based on its usefulness or importance to the consumer

### The Invention

The components of the system are: 1) a real estate brochure with an embedded transponder (RFID); 2) readers for data collection (cell phone, PDA, or computer); and 3) a database. The architecture of the RFID tagged brochure and its integration with personal experiences, is described below.

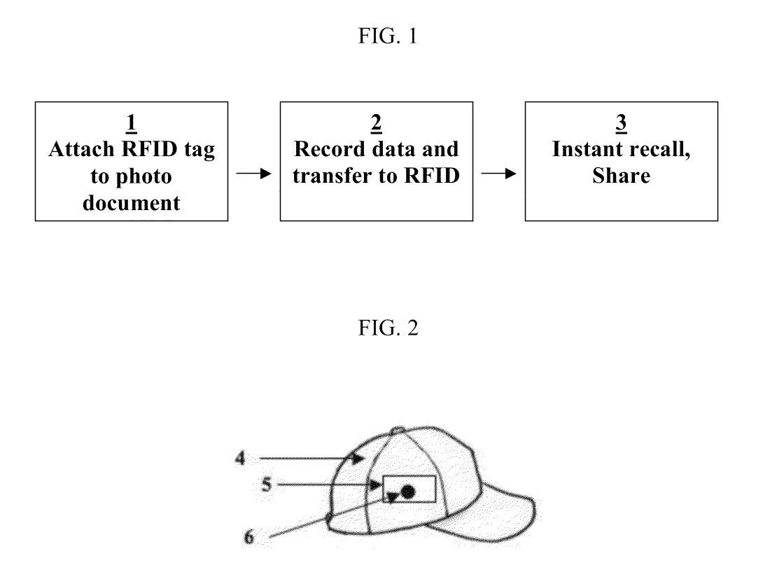

Referring to FIG. 1, “RFID Data flow”, the steps of the process and data flow are shown schematically. The process consists of 1) attaching an RFID tag to a photo document; 2) record and transfer to RFID personalized event information; and 3) recall and share the event information by placing an RFID-enabled cell phone, computer, or PDA near the tagged brochure.

Referring to FIG. 2, “RFID hat 4,” the components are shown. These are 4) a consumer item; 5) a patch; and 6) a miniature RFID transponder holding a unique serial number. The tag also contains memory chips with an embedded software program. These components are passive and do not contain batteries. They receive and transmit data only when interrogated by the appropriate readers.

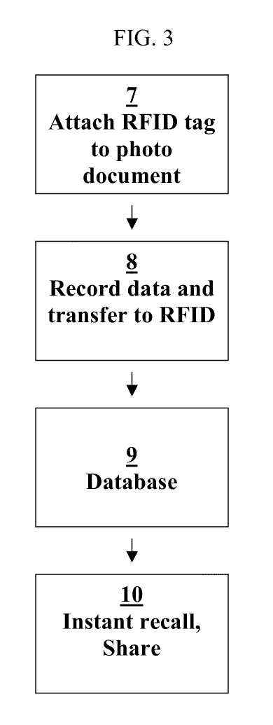

Referring to FIG. 3, “RFID Data flow”, the steps of the process and data flow are shown schematically. The process consists of 7) attaching an RFID tag to a photo document; 8) record and transfer to RFID, personalized event information or links to personalized event information; 9) retrieve information from database; and 10) recall and share the personalized event information. The RFID tag contains a factory programmed number. A large number of bits are used (typically at least 39) to allow a unique set of serial numbers. The RFID tag contains the programmed information, but is otherwise blank. Information can be written on the RFID using a modified cell phone or PDA that has both a RFID reader and writer. The RFID number is read from and written into a specific field of the tag memory. Data stored on the chip may also be encrypted to provide for security requirements. DES and other commercial encryption methods may be applied to ensure the security of the information.

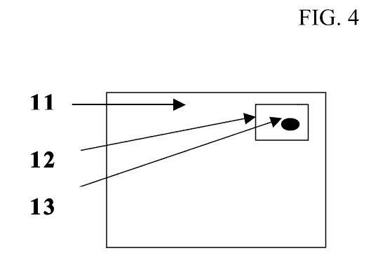

Referring to FIG. 4, “RFID postcard 11”, the components are shown. These are a postcard; a stamp 12; and a miniature RFID transponder 13.

### EXAMPLES OF THE PREFERRED EMBODIMENTS

The following examples further illustrate the present invention. These examples are intended merely to be illustrative of the present invention and are not to be construed as being limiting.

### Examples

### Example 1

### Using RFID Technology to Record a Visit to the Beach

RFID technology can be used to record events. This process has been demonstrated in the tropical outdoors. RFIDs have been used in Hawaii at Kailua beach on the island of Oahu.

In order to retrieve information, the Treo 650 cell phone (Cingular) was placed in close proximity to the RFID tag. Unlike traditional barcodes, the transponder (RFID tag) does not need to be in direct line of sight. It can be embedded in clothing, plastic, recreational equipment that can be covered with material or debris. This feature is important in outdoor settings where dirt, salt, snow, rain and dust is prevalent. For our beach experiment, a label containing the transponder was placed directly behind a patch that was embroidered into a towel. The GPS location of the beach was directly written on the RFID tag. To initiate the process, a touch screen button was pressed to activate cell phone. The RFID receiver switched to the detection mode and read the tag. An attention signal displayed on the reader indicated that RFID device had been found and that the data had been transferred. The unique sixteen-decimal RFID identifier was displayed on the screen along with the local position (ex. E0070000021BF33C Kailua). A photo of a dog on the beach was taken using the camera on the cell phone. Audio information about the event (e.g. early morning sunrise at the beach) was recorded and directly linked to the picture. The name of the photo was changed to ZEN1 and entered into the cell phone contact database. This program is normally used to store addresses and telephone numbers. In order to locate the exact file a query was performed on the cell phone searching for the photo ZEN1. The information can also be found by searching the database for the unique RFID number.

The precise location of Kailua beach was recorded using a GPS enabled PDA. The GPS reading was photographed using the cell phone. The name of the photo was changed to ZEN2 and sent by multimedia messaging to a personal email account. This information was later used to update a remote database. In addition, the actual GPS reading was written on the RFID tag. To initiate this process, a touch screen button on the cell phone was pressed to activate the Ande 929 RFID program (Tradewinds). The GPS reading and additional data was entered using the digital keypad on the cell phone. A touch screen button was then pressed and the receiver switched to the writing mode and recorded the information on the RFID tag. The newly entered data was verified using the cell phone RFID reader.

Data links that were written on the RFID tags have been used to instantaneously retrieve text, photos and audio files. The information was archived on local and distal databases. The photos were viewed on the PDA or cell phone display and the audio files were replayed using the embedded speaker. Personalized information such as name, date, location, and GPS that were directly written on the RFID tag were simultaneously viewed on the receiver's screen while seeing the photographs and listening to the audio files. This process provided a rich, integrated way to view memorable events. Our mobile method has allowed the user to recall a special event and directly link it to a recreational object (beach towel).

### Example 2

### Open House Viewing Using RFID Real Brochures

We have developed a system that uses RFID tags to provide links between information concerning real estate properties, GPS, photos, and audio files. We made interactive real estate brochures using RFID technology. In this process (FIG. 1), we used a Nokia 6212 cell phone (Keilalahdentie, Finland) to write and retrieve information. The Nokia 6212 was placed in close proximity (less than 5 cm) to a brochure containing a photo and embedded RFID devices. The tags were hidden behind the photo of the house. The cell phone was used to record personal photos and videos during a tour of an open house. The photo and video file were stored in the cell phone's microSD card. Links to the personal open house photos and movies were written on RFID tags that were embedded in the brochure using a Nokia 6212 cell phone. Audio information about the open house was also recorded and directly linked to the RFID-tagged brochure. Additional information such as GPS coordinates, date, and real estate agent contact information was written on other RFID tags that were embedded in the brochure. At a latter point in time the personal information about the open house was recalled by placing the Nokia 6212 cell next to the RFID tags that were embedded in the brochure. Videos, photos, audio, and text messages were displayed on the screen of the cell phone. The personal information was shared with friends and relatives using cellular networks, email, text, and multimedia messaging. This process provided a rich, integrated way to view real estate data. This mobile method allowed users to recall an address, photos, videos, listing price, personal comments, and directly link it to a house for sale.

### Example 3

### Recording Catch Data on a Fishing Pole

A rectangular 1¼″ by 2″ RFID tag was attached to a deep sea fishing pole and tested in Taveuni, Fiji. On Aug. 6, 2005, barracuda, tuna, and walu were caught trolling artificial lures. A photo of the fish was taken using a Treo 650 cell phone. The name of the photo was changed to the unique RFID identifier (E0070000021BF377) and sent via multimedia messaging (MMS) to an email account. Information about the fishing trip (type of fish, size, date and location) was written on the RFID tag. Data links that connect the photos, text, and audio files were also written on the RFID tag. The subject line of the multimedia message contained the unique RFID number. Upon returning to the United States, memories of the Fijian fishing trip were shared with friends using RFID technology. In this process, a RFID-enabled cell phone was placed adjacent to the tag. A touch screen button was pressed instructing the phone to read the tag. The unique sixteen-decimal RFID identifier was displayed on the screen along with the catch data, date, and fishing location. The unique RFID identifier was used to search the cell phone multimedia database. Since the subject line of the MMS contained the RFID identifier, the cell phone search engine quickly located the information. The specific multimedia message containing fishing photos, text, and audio files was retrieved and displayed on the cell phone. This process provided a rapid method to recall the fishing trip and directly linked it to a recreational object that contained the RFID tag (fishing pole). In addition, the multimedia message about the Fijian fishing trip was sent to relatives and friends by email. This process could lead to an enhanced interest in Fiji, fishing, vacations, and tropical resorts. By attaching or embedding the RFID tags to consumer items, it will increase the value of those items that were purchased during the trip. Using RFID technology we have developed a method to personalize inanimate objects.

### Example 4

### Recording Catch Data on a Fishing Hat

A rectangular 1¼ ″ by 2″ RFID tag was used to record fishing data in Kenai, Alaska. On Jun. 29, 2005, three King salmon were caught from a boat on the Kenai river. A photo of the fish was taken with the Treo 650 cell phone. The name of the photo was changed to the unique RFID number (E007000002003078) and sent via multimedia messaging (MMS) to an email account. The fish were measured and recorded on the RFID tag. A 43 inch salmon was brought on board the boat and the other two (48 inch and 49 inch) salmon were released alive. Additional information about the fishing trip (type of fish, estimate weight, date, and location) was written on the RFID tag. The data link that connected the photos, text, and audio files was the RFID tag number. The subject line of the multimedia message contained the unique RFID number. Upon returning to Hawaii, the RFID tag was embedded inside of a fishing hat (FIG. 2) that was purchased in Alaska. Memories of the Alaskan fishing trip were shared with friends using RFID technology. In this process, a RFID enabled cell phone was placed adjacent to the fishing hat containing the tag. A touch screen button was pressed instructing the phone to read the tag. The unique sixteen-decimal RFID identifier was displayed on the screen along with the catch data, date, and fishing location. The unique RFID identifier was used to search the cell phone multimedia database. Since the subject line of the MMS contained the RFID identifier, the cell phone search engine quickly located the information. The specific multimedia message containing fishing photos, text, and audio files was retrieved and displayed on the cell phone. This process (FIG. 3) provided a rapid method to recall the fishing trip and directly linked it to a fishing hat that contained the RFID tag. In addition, the experience was shared with others by emailing the multimedia message to relatives and friends.

### Example 5

### Recording a Birthday Celebration on a Postcard

A rectangular 1¼″ by 2″ RFID tag was used to record a birthday party in Honolulu, Hawaii. On Apr. 10, 2005, a birthday was celebrated at the Honolulu Aquarium. A photo of a saltwater fish tank was taken with the Treo 650 cell phone. The name of the photo was changed to the unique RFID number (E0070000125003B5) and sent via multimedia messaging (MMS) to an email account. Additional information about the birthday (date, name, and location) was written on the RFID tag. The data link that connected the photos, text, and audio files was the RFID tag number. The subject line of the multimedia message contained the unique RFID number. Upon returning home, the RFID tag was place in back of a postcard that purchased from the Honolulu Aquarium. Memories of the birthday party were shared with friends using RFID technology. In this process, a RFID-enabled cell phone was placed adjacent to the postcard containing the tag. A touch screen button was pressed instructing the phone to read the tag. The unique sixteen-decimal RFID identifier was displayed on the screen along with the birthday girl's name, date, and location. The unique RFID identifier was used to search the cell phone multimedia database. Since the subject line of the MMS contained the RFID identifier, the cell phone search engine quickly located the information. The specific multimedia message containing aquarium photo, text, and audio files was retrieved and displayed on the cell phone. This process provided a rapid method to recall the birthday party and directly linked it to a postcard that contained the RFID tag. In addition, the experience was shared with others by emailing the multimedia message to relatives and friends.

### Example 6

### RFID Enabled Business Card

An RFID tag (HID Inc., Irvine, Calif.) was attached to a business card. The URL for the Kenai River Retreat (www.kenairiverretreat.com) was written on the tag using a RFID AirID Writer (RF Ideas, Arlington Heights, Ill.). An additional rectangular 1¼″ by 2″ RFID tag that was attached to the same business card was used to record events. On Jun. 26, 2005 a photo of two calves and large female moose was taken from the back porch of the condo at the Kenai River Retreat using a digital camera. The name of the photo was changed to the unique RFID number (E0070000021BF332) and sent via multimedia messaging (MMS) to an email account. Additional information about the wildlife (name of animals, location, and date) was written on the RFID tag. The subject line of the multimedia message contained the unique RFID number. Memories of the moose sighting and the Kenai River Retreat were shared with friends using RFID technology. In this process, a RFID enabled cell phone was placed adjacent to the business card containing the tag. A touch screen button was pressed instructing the phone to read the tag. The unique sixteen-decimal RFID identifier was displayed on the screen along with the moose sighting, name of the resort, date, and location. Additional information about the accommodations was obtained using a Macintosh PowerBook G4 laptop computer. In this process, the URL box in the Netscape search engine was highlighted. The business card was placed on an Air ID playback USB reader (RF Ideas, Arlington Heights, Ill.) that was connected to the computer. The URL and an additional keystroke (enter) that was written on an RFID tag was automatically entered into Netscape and the homepage of Kenai River Retreat was displayed on the computer screen. This process provided a rapid method to recall the experience of seeing a family of moose in Alaska. It linked the business card and home page of the resort to a personal event.

### Example 7

### Temperature Testing of RFID Tags and Labels

One of the major advantages of RFID tags is that they are extremely durable. Since the passive transponders (RFID tags) do not require batteries they can withstand extreme temperatures. This feature is important in outdoor settings where the devices are used at different elevations and are exposed to various temperature regimes. In our environmental tests, information was written on the tags using handheld devices. They were then subjected to various temperature conditions for at least 30 minutes. In order to retrieve the data, the devices were returned to room temperature and read. We tested the ability of Picotags (Inside Contactless, France) and Ti-tags (Texas Instruments, Dallas, Tex.) to store information at −80° C., −20° C., 25° C., and 100° C. The RFID tags were also submersed in liquid nitrogen for 15 minutes and autoclaved for 20 minutes. Both of the tags were able to work in all of the conditions that were tested.

### Example 8

### Testing of RFID Tags and Labels in Aqueous Liquids and Organic Solvents

In our experiments compounds from plants are extracted into aqueous buffers or organic solvents. In order to reduce the chance of mislabeling RFID tags are placed in the voucher bags or tubes along with the plant samples. This procedure requires the transponders (RFID tags) to be exposed to various liquid solutions. We have submerged the RFID tags in organic solvents such as alcohol, phenol, acetonitrile, and chloroform. They have also been tested in aqueous buffers and salt water. Information on the tags was obtained by reading the devices semi-wet (in solution) or after they were removed from the liquid. The RFID tags were fully functional in all of the solvents and aqueous solutions tested. The transponders could withstand a variety of chemical conditions including plant extracts in organic solvents that were stored at −80° C. Information could be updated on the tag without removing the tag from the falcon tube containing the plant extract. This feature is useful because we have been able to enter results from assays on the tags without thawing out the sample.

### Example 9

### Testing of RFID Tags and Labels in Outdoor Tropical Sunlight

The RFID tags might be embedded or attached to outdoor recreational, consumer items such as skis, bicycles, climbing equipment, fishing poles, sun glasses, gloves, shoes, and hats. One of the major challenges of spending time in the tropical or outdoor environment is material damage caused by exposure to the intense sunlight. In order to address this issue, a rectangular 30 mm×30 mm Picotag (Inside Contactless, France) was attached to mango tree using monofilament line. Information that included the date, location, and type of tree (mango) was written directly on the tag using a Handspring PDA (Palm, Sunnyvale, Calif.) that was equipped with an Inside Contactless RFID reader. A yellow wristband containing a transponder was also attached to the tree. The same data was written on the RFID tag using a Tradewind Treo 650 reader. Six months later information from both of the RFID tags was retrieved. The tags were stable when exposed to tropical sunlight for at least six months.

### Example 10

### Replaying Catch Data on a RFID Enabled Fishing Pole Using Multimedia Messaging

A photo of a fish, GPS, and time stamp was recorded using a RFID cell phone or RFID PDA. The information was relayed to an electronic web page and the unique address was recorded on a RFID tag that was operationally attached to a fishing pole. Information about the event was retrieved using the RFID cell phone or RFID PDA and was sent as a multimedia message.

### Example 11

### Gardening

We used a RFID reader (Tradewind Technologies LLC, Knoxville, Tenn.) that was attached to Treo 650 cell phone (Palm, Sunnyvale, Calif.). The device was placed in close proximity (less than 5 cm) to the RFID tags. Unlike traditional barcodes, the RFID tag does not need to be in direct line of sight of the reader. The tag can be embedded in the container holding the potted plant or covered with material or debris. This feature is important in outdoor settings where dirt, salt, snow, rain and dust is prevalent. To initiate a greenhouse experiment, a label containing the transponder was placed on the outside of a container. The RFID receiver was switched to the detection mode and an attention signal was displayed on the reader that indicated the RFID tag had been found. In this process, a unique sixteen-decimal RFID identifier was displayed on the screen (ex. E0070000021BF333). The precise location of the plant was obtained using a GPS enabled PDA. The GPS position of the potted plant was directly written on the RFID tag. To initiate this command, a touch screen button was pressed to activate the Ande 929 RFID program (Tradewind Technologies LLC, Knoxville, Tenn.). The GPS reading, date, and additional data were entered using the digital keypad on the cell phone. A touch screen button was then pressed and the receiver switched to the writing mode and recorded the information on the RFID tag. A photograph of the plant was taken using the camera on the Treo 650 cell phone. Audio information about the experiment was also recorded and directly linked to the picture. The name of the photo was then changed to RFID identifier and entered into the cell phone contact database. This program is normally used to store addresses and telephone numbers. The photo, text, and audio files were sent to a personal email account by cell phone MMS. The subject line for the email message was the RFID number. This labeling system allowed the RFID tag to be linked to the MMS message.

In order to retrieve specific plant data, a query for the RFID number was initiated on the cell phone. Since the contact information, photo, and MMS contained the RFID number, the unique plant specific information was rapidly obtained. RFID tags, cell phones, and multimedia messaging were used to instantaneously retrieve information (photos and audio files) that was archived on local or distal databases. In this process the photos were viewed on the cell phone display and the audio files were replayed using the embedded speaker. Personalized information such as name, date, nucleotide sequence, location, and GPS that was directly written on the RFID tag could be simultaneously retrieved on the receiver's screen along with photographs and the audio files. This process provided a rich, integrated way to view data. This mobile method allowed users to recall a specific event, or photo and directly link it to a plant.

There is limited space for storing data on the cell phone. To address this concern, we set up a system to transfer the RFID data to an external database. In this process we modified the cell phone address book by changing the field names. Information was rapidly transferred to portable computers via Bluetooth, IR, or USB HotSync connections. The information was then exported into Filemaker (Santa Clara, Calif.) databases that were used on Macintosh and PC Windows platforms. Multimedia messages that were sent by the cell phone to the portable computers could be imported into Filemaker using publicly available scripts.

### Example 12

### Forwarding Catch Data Using a RFID Enabled Cell Phone

RFID readers may become a standard feature in all cell phones. Nokia (Keilalahdentie, Finland) has introduced RFID shells for several of their GSM phones. We tested the Nokia 5140 because it is built for the outdoors. The compact, water resistant phone contained a compass, camera, and flashlight. The Nokia 5140 “shortcut” program was used to send RFID specific, SMS messages to other cell phones and email messages to portable computers. This feature is useful in outdoor recreational events where information about the sporting event is forwarded to external databases. In the outdoors, information about a specific fishing trip was sent on location to an external database. The information exchange was initiated by touching the back of phone to the tag. Using the cell phone keypad, the tag was defined by entering the telephone number/email address, RFID number, location, photo name, and catch data. The message was sent to an email address and phone number by placing the phone next to the tag. A log of the messages with a time stamp was automatically recorded on the cell phone.

### Example 13

### Recording Catch Data on a RFID Enabled Fishing Lure

On Jun. 19, 2005, a photo of a 170 lb halibut, GPS, location (Kodiak, Ak.), date, and voice recording was electronically recorded using a Treo 650 cell phone and a Tradewinds RFID reader. The information was stored on the cell phone and sent to a portable computer using multimedia messaging. The subject line of the message was the unique RFID number. The RFID tag was operationally attached to the fishing lure. In order to recall the event, the cell phone/RFID device was placed next to the lure and a RFID query was initiated. The information that was recorded on the RFID tag appeared on the screen of the cell phone/RFID device. Additional information such as the photo and voice recording was obtained by searching the cell phone multimedia messages for the unique RFID number. This method allows for an instant replay of the event. The value of the recreational object (lure) was enhanced by retrieving and replaying personalized data using cell phone and RFID technology.

### Example 14

### Recording a Memorable Skiing Event Using RFID

The invention functions as a device to replay, recall, or reenact a memorable event. The RFID tag contains a unique identifier and is used to record information and links to additional data. A PDA, computer, or smart cell phone containing a RFID reader is used by the owner to replay an event that involved a specific recreational item. The ability to recall the event using a RFID tag and reader enhances the value of the recreational item. The invention can be used to increase the intrinsic value of recreational items. The tag may be attached to or embedded in gloves, clothing, hats, and ski equipment. The tag system can have information about the owner, date, location and event. Using a cell phone the user can photograph an outdoor scene and record an audio message. The image and voice data is digitally stored on the cell phone. The information (photo and audio file) is given unique identifiers (UIDs) that can be written on the RFID tag. This method allows for a direct link between the RFID-enabled recreational item and data collected at the event. The advantage of the system is that it allows user to add information and data links to an object as the event occurs. This will reduce errors in labeling and retrieving valuable information.

In order to recall an event, the user places the PDA or cell phone in close proximity to the RFID enabled item. In one instance, the user presses a button or voice activates the receiver to read the tag (PDA or cell phone) so that it switches to a detection mode. An attention signal can be displayed on the reader indicating that RFID device has been found and that the data has been transferred. Data links that are written on the tag are used to instantaneously retrieve information (photos and audio files) that has been archived on local or distal databases. The photos are viewed on the PDA or cell phone display and the audio files are replayed using the embedded speaker. Personalized information such as name, date, location, elevation, and GPS that was directly written on the RFID tag can be simultaneously viewed on the receiver's screen while seeing the photographs and listening to the audio files. The process provides a rich, integrated way to view historical events. This mobile, data intensive method allows a user to recall a special experience and directly link the memory to a recreational object. The experience can be shared with others by emailing a RFID multimedia message to relatives and friends.

### Example 15

### House Hunting Using RFID Real Estate Playing Cards

We have developed a system that uses RFID tags to provide links between information concerning real estate properties, GPS, photos, and audio files. We have organized the data in an easy visual format using a layout that we term, RFID Real Estate Playing Cards. In this process used a Tradewind Technologies RFID reader that was attached to Treo 650 cell phone (Palm, Sunnyvale, Calif.). The device was placed in close proximity (less than 5 cm) to a brochure containing a photo and an embedded RFID device. The tag was hidden behind the photo of the house. To initiate a record during a tour of an open house, the RFID receiver was switched to the detection mode and an attention signal was displayed on the reader that indicated the RFID tag had been found. In this process, a unique sixteen-decimal RFID identifier was displayed on the screen (ex. E0070000021BF333). The precise location of the house was obtained using a GPS enabled PDA. The GPS position of the house was directly written on the RFID tag. To initiate this command, a touch screen button was pressed to activate the Ande 929 RFID program (Tradewind Technologies LLC, Knoxville, Tenn.). The GPS reading, date, and additional data were entered using the digital keypad on the cell phone. A touch screen button was then pressed and the receiver switched to the writing mode and recorded the information on the RFID tag. A photograph of the house was taken using the camera on the Treo 650 cell phone. Audio information about the experiment was also recorded and directly linked to the picture. The name of the photo was then changed to RFID identifier and entered into the cell phone contact database. This program is normally used to store addresses and telephone numbers. The photo, text, and audio files were sent to a personal email account by cell phone MMS. The subject line for the email message was the RFID number. This labeling system allowed the RFID tag to be linked to the MMS message. In order to retrieve specific information on the house, a query for the RFID number was initiated on the cell phone. Since the contact information, photo, and MMS contained the RFID number, specific information on the house was rapidly obtained. This process provided a rich, integrated way to view real estate data. This mobile method allowed users to recall an address, photos, listing price, personal comments, and directly link it to a house for sale.

### Example 16

### Creating an RFID Real Estate Brochure

We have made an interactive real estate brochure that was used to advertise a home for sale. A Mifare RFID tag was attached to a sheet of paper that described the property in Kailua, Hi. Informational links about the home and real estate listing agency was written on the RFID tag. The data included GPS readings, links to photo, audio, and video files. We also transferred an additional link to a personal video file that was located on the internet (YouTube). This was an example of potential buyer's video. We used a Nokia 6131 NFC cell phone to read the personalized real estate brochure and send a text message containing the information to an Apple iPhone. By pressing a link on the screen the potential buyer's video was downloaded from the internet and displayed on the iPhone. Using RFID technology and the cell phone we have been able to directly link a real estate flyer with a specific a personal video. Information about the house was replayed on the screen of the cell phone. RFID technology was used to quickly retrieve information that was previously recorded. This technology will provide information to a client that will help them make an informed decision. The information was presented on a mobile phone and was quickly shared with others using cellular technology.

### Example 17

### Creating an RFID Real Estate Postcard

We have placed a small Mifare RFID tag on a real estate postcard. In order to hide the tag, we placed a stamp over the RFID tag (FIG. 4). We used the card to record and share our personalized real estate viewing experiences with friends and relatives. The RFID tagged post card allowed us to recall personalized real estate viewing events, open houses, people, and places. In this process, we used a Nokia 6212 cell phone (Keilalahdentie, Finland) to write and retrieve information. The Nokia 6212 was placed in close proximity (less than 5 cm) to a postcard containing a photo and embedded RFID device. The tag was hidden behind the postage stamp. The cell phone was used to record a personal video during a tour of an open house. The video file was stored in the cell phone's microSD card. Links to the personal open house movie was written on RFID tag that was embedded in the postcard using a Nokia 6212 cell phone. At a latter point in time the personal information about the open house was recalled by placing the Nokia 6212 cell next to the RFID tag that was embedded in the postcard. The personalized video was displayed on the screen of the cell phone. The personal information was shared with friends and relatives using cellular networks, email, text, and multimedia messaging. This process provided a rich, integrated way to view real estate data. This mobile method allowed users to recall an address, video, listing price, personal comments, and directly link it to a house for sale. By viewing and sharing our personalized impressions, we are able to make informed decisions about real estate purchases.

### Example 18

### Creating an RFID Postcard

We have placed a small Mifare RFID tag on a postcard. In order to hide the tag, we placed a stamp over an RFID tag. We can now use the card to record and share our outdoor experiences with friends and relatives. Memories from the past allow us to recall wonderful events, people, and places. By sharing these thoughts we are able to relive the past and plan on the future. Links to videos can be written on the tags. Using a wireless connection we have accessed our YouTube site and copied the URL of a recent video. It was then pasted on a desktop widget that was used to send it by Bluetooth to a Nokia 6131 NFC cell phone. With a push of a button the information was written on the tag. We used the same Nokia 6131 NFC cell phone to read the tagged postcard and send a text message containing the information to an Apple iPhone. By pressing a link on the screen a YouTube video was downloaded from the internet and displayed on the iPhone. Using RFID technology and the cell phone we have been able to directly link a postcard with a specific a memory (photo, audio, or video file) from the past.

### Example 19

### Sharing Outdoor Activities Using an RFID-Enabled Book

We have made an enhanced book that uses RFID tags to provide links to information concerning outdoor recreational sports, GPS, photos, and audio files. We have placed Mifare 1K tags behind the photos of recreational objects (ie. lures, fishing poles, hats, etc.) and organized the data in an easy visual format using a layout that we term, RFID-enhanced books. Personalized, memories from the past can be associated with pages in book. In this process, we used a Nokia 6131 NFC phone (Keilalahdentie, Finland) to read and send the informational links to an Apple iPhone. When the Nokia device was placed in close proximity (less than 5 cm) to a page in the book containing an RFID tag it automatically read the embedded data. Information from the tag was then displayed on the NFC cell phone and then sent to the Apple iPhone. By pressing the URL link on the screen, a video file was downloaded from the internet and displayed on the iPhone. The entire process allowed a reader to associate a video with a photo from the enhanced book. In one example, a tagged photo of a lure was linked to an outdoor adventure fishing video. The RFID-enhanced book allowed the reader an interactive reading experience. By touching the NFC phone to visual cues (ie. tagged photos) additional information can be obtained. Personal information such as text, links to audio, and video files can be written on the tags by the reader using the NFC phone. This application can also be used in enhanced travel, dining, and cooking books. Readers can customize their books by adding personal information to the RFID tagged pages. Unique experiences can be documented and shared with others using NFC cell phones. A link to a video file from a tagged photo in a book could be shared with friends and relatives by text, multimedia messaging, and email. Messages and phone calls derived from interactive experiences using enhanced books can be used to advertise products and places.

### Example 20

### Treasure Hunt Using RFID Tags

We have developed an outdoor recreation game that uses RFID tags, cell phones, MMS, and GPS. In this game a RFID user hides an object that contains an RFID tag. The player then publishes the GPS coordinates so that other RFID users could go on a “treasure hunt” to find the cache. The game was conducted in the outdoor environment. Clues to the treasure (including GPS readings and photos) were posted on internet sites, brochures, and consumer items. Electronic information was stored on RFID tags that were hidden in the environment. Players of the game located the RFID tags and caches using GPS and RFID readers. When the objects were found, data, personalized information, and links to internet web pages were written on the tags using RFID enabled cell phones or PDAs. Instructions, directions, or clues to nearby buried caches were included on the tags. Additional, personalized information such as photos, videos, and audio files were uploaded to electronic databases on the internet. Date, time, RFID identification number, GPS coordinates, audio files, and photos were sent to email accounts by cell phone MMS. The subject line for the email message was the RFID number. This labeling system allowed the player, treasure, and RFID tag to be linked to the MMS message. This mobile game allowed users to recall an event and directly link it to buried treasure.

### Example 21

### RFID Trophy

RFID-enabled trophies can be used to replay, recall, or reenact a sporting event. In this example a RFID tag was attached to a trophy. During a children's soccer game, we used a cell phone to record and store information (audio, photo, and video files). Winners and participants of the game or contest were awarded trophies. We physically attached a RFID tag to the bottom of the trophy. Links to the data files were written on the RFID-enabled trophy. Additional information such as name, date, time, and location were written on the tag using a Treo 650 cell phone and a Tradewinds RFID reader. The trophy was placed in a display case for viewing and storage. In order to recall the memorable event, the cell phone/RFID device was placed next to the trophy and a RFID query was initiated. The information that was recorded on the RFID trophy appeared on the screen of the cell phone/RFID device. Additional information such as photo and voice recordings was obtained by searching the cell phone database. The experience was shared with relatives and friends by emailing a RFID multimedia message.

### INCORPORATION BY REFERENCE

All patents, patents applications, and publications cited are incorporated herein by reference.

### EQUIVALENTS

The foregoing written specification is considered to be sufficient to enable one skilled in the art to practice the invention. Indeed, various modifications of the above-described makes for carrying out the invention which are obvious to those skilled in the art are intended to be within the scope of the following claims.

1. A personalized photo document, comprising:
a) a photo document; and
b) an RFID tag attached to the photo document, the RFID tag comprising personalized event related information and/or a link to the information that is electronically deposited on the RFID tag.

2. The personalized photo document of claim 1 wherein said photo document is selected from the group consisting of:
a) a book wherein the book contains photographs;
b) a card wherein the card is a business card;
c) a card wherein the card is a holiday card, wedding card, or birthday card;
d) a card wherein the card is a for sports and/or non-sports trading cards;
e) a ticket wherein the ticket concert ticket;
f) a post card wherein the post card contains a photograph;
g) photo label wherein the photo label is on a consumer food item;
h) photo label wherein the photo label is on a consumer electronic item;
i) photo label wherein the photo label is on a CD or DVD media disc;
j) a brochure wherein the brochure is a real estate advertisement;
k) a brochure wherein the brochure is a restaurant advertisement
l) a brochure wherein the brochure is a travel destination advertisement;
m) a brochure wherein the brochure is an outdoor recreational sport advertisement;
n) a brochure wherein the brochure is an amusement park advertisement; and
o) a brochure of a vehicle wherein the vehicle is a scooter, a car, a motorcycle, an airplane, a train, a boat, or a skateboard.

3. A method of recording, personalizing, and recalling a personal event from a photo document, comprising:
a) attaching an RFID tag to a photo document;
b) recording personalized event information involving a personal event;
c) transferring the personalized event information or links to the personalized event information to the RFID-tagged photo document wherein the event information is recorded during the event;
d) replaying the personalized event information by placing a cell phone, computer, or PDA near the RFID-tagged photo document; and
e) sharing the personalized event information.

4. The method of claim 3 wherein the photo document is a real estate brochure that is enhanced by the steps comprising:
a) attaching an RFID tag to the real estate brochure;
b) viewing the property with the RFID-tagged brochure;
c) recording personalized event information comprising of personal photos, text messages, audio files, and video files;
d) transferring the personalized event information or links to the information to the RFID-tagged brochure to be recalled later; and
e) recalling and sharing the personalized event information.

5. The method according to claim 3 wherein attaching an RFID tag to a photo document is selected from the group consisting of:
a) an RFID-tagged photo document that is prepared by printing a photograph on paper that contains an RFID tag;
b) an RFID-tagged photo document that is prepared by printing an instant photograph on media that contains an RFID tag;
c) an RFID-tagged photo document that is prepared by copying an image onto paper that contains an RFID tag;
d) an RFID-tagged photo document that is prepared by placing an RFID tag on the non photo side of the photo document; and
e) an RFID-tagged photo document wherein the photo document is a post card that has an RFID tag behind the stamp.

6. The method of claim 3 wherein personalized event information is deposited on the RFID tag before, during or after an event to which the personalized photo document is relevant.

7. A method of recording and recalling a consumer experience, comprising:
a) associating an RFID tag to a photo document to allow the RFID-tagged document to be associated with an event;
b) experiencing said event with the RFID-tagged photo document;
c) recording information comprising personal and historical information associated with said event;
d) depositing the information or links to the information on the RFID tag that is associated with the photo document so that the event can be recalled from the RFID tag that is associated with the document; and
e) recalling said information.

8. The method according to claim 7 further comprising sharing said information.

9. The method according to claim 7 wherein said RFID-tagged photo is selected from the group consisting of:
a) a book wherein the book contains photographs;
b) a card wherein the card is a business card;
c) a card wherein the card is a holiday card, wedding card, or birthday card;
d) a card wherein the card is a for sports and/or non-sports trading cards;
e) a ticket wherein the ticket concert ticket;
f) a post card wherein the post card contains a photograph;
g) photo label wherein the photo label is on a consumer food item;
h) photo label wherein the photo label is on a consumer electronic item;
i) photo label wherein the photo label is on a CD or DVD media disc;
j) a brochure wherein the brochure is a real estate advertisement;
k) a brochure wherein the brochure is a restaurant advertisement
l) a brochure wherein the brochure is a travel destination advertisement;
m) a brochure wherein the brochure is an outdoor recreational sport advertisement;
n) a brochure wherein the brochure is an amusement park advertisement; and
o) a brochure of a vehicle wherein the vehicle is a scooter, a car, a motorcycle, an airplane, a train, a boat, or a skateboard.

10. An RFID personalized photo document system comprising:
a) a recording device;
b) an RFID tag attached to a photo document, wherein the RFID tag contains personalized event-related information or links to event-related information that has been captured by the recording device and electronically deposited on the tag;
c) an information retrieval device; and
d) a database.

11. An RFID personalized photo document system according to claim 10 wherein the recording and retrieval device is an RFID enabled cell phone, an RFID-enabled PDA, or an RFID-enabled computer.

12. An RFID personalized photo document system according to claim 10 wherein the recording and retrieval device is a RFID-enabled music, photo, and video player.

13. A method of using an RFID tag, the method comprising recording on the RFID tag personalized event information such as location, time, and events that are associated with a real estate viewing event, wherein the RFID tag is attached to a photo document that is associated with said real estate viewing event.

14. A method according to claim 13 wherein the real estate viewing event is a one-time event, a periodic event, or an occasional event or a reoccurring event.

15. The method according to claim 13 wherein said RFID-tagged photo is selected from the group consisting of:
a) a book wherein the book contains photographs;
b) a card wherein the card is a business card;
c) a post card wherein the post card contains a photograph;
d) photo label wherein the photo label is on a CD or DVD media disc; and
e) a brochure wherein the brochure is a real estate advertisement.
